(19) United States
(12) Patent Application Publication
(10) Pub. No.: US 2005/0072257 A1
(43) Pub. Date: Apr. 7, 2005

(54) SRAM cell with read-disturb immunity

(75) Inventor: Schuyler E. Shimanek, Albuquerque, NM (US)

Correspondence Address: XILINX, INC;ATTN: LEGAL DEPARTMENT, 2100 LOGIC DR, SAN JOSE, CA, 95124, US

(73) Assignee: Xilinx, Inc., San Jose, CA (US)

(21) Appl. No.: 10/680,054

(22) Filed: Oct. 6, 2003

(51) Int. Cl. F16H 57/10

(52) U.S. Cl. 74/411.5

(57) ABSTRACT

A linear actuator with dual direction self-locking mechanism which can lock the load if linear actuator at the position where power stop. The self-locking mechanism includes a transmission device, an actuating unit and a spring. This mechanism can unlock the linear actuator automatically without producing extra load during the operation of the linear actuator, which can be applied to linear actuator with both pull and push load.

### BACKGROUND OF THE INVENTION

1. Field of the Invention

The present invention relates to a linear actuator with dual direction self-locking mechanism, and more particularly to a linear actuator which can lock the actuating unit automatically after the linear actuator is stopped, so as to lock the load at the position where power stop.

2. Description of the Prior Arts

Linear actuator generally comprises base body, motor, output shaft and transmission shaft. The motor serves to output torque and, through scroll wheel, the torque is transmitted to the output shaft, since the output shaft is axially connected to the transmission shaft, the torque is then transmitted to the transmission shaft. The transmission shaft is provided with screw shaft, and the screw shaft is coupled with screw nut that connected with a load inner tube. When the screw shaft rotates along with the transmission shaft, the screw nut serves to turn the torque of the screw shaft into linear pushing or pulling force so as to cause reciprocating motion the load inner tube, and thus drive the workpiece to move.

In case that the conventional linear actuator has no self-locking mechanism, the lock of the actuator is achieved by frictions between relative mechanisms, but the shortcoming is that the working speed of the actuator is slowed down and extra load is produced. In case that the conventional linear actuator has self-locking mechanism, the self-locking device of which serves to lock the transmission shaft after the motor is stopped, so as to lock the load at the position where the motor stops. As disclosed in EP 0662573, wherein a spring is mounted onto a transmission shaft, a leg of the spring is fixed on a base body. The method of self-locking is that when the motor drives the transmission shaft to push the load, the spring is loosened and at this moment it plays no role. However, when the motor stops working, the transmission shaft, under the influence of the gravity of the load, will be pushed to rotate in a reversed direction. At this moment, the spring is tightened so as to the lock the transmission shaft. The disadvantage of this structure is that it only has an ability of unidirectional self-locking, when the motor rotate reversely to withdraw the load, the load only can be withdrawn on the condition that the torque of the motor is greater than the self-locking torque of the spring, and thus results in an extra load on the motor.

The present invention has arisen to mitigate and/or obviate the afore-described disadvantages of the conventional linear actuator.

### SUMMARY OF THE INVENTION

The primary object of the present invention is to provide a linear actuator which generally comprises power unit, transmission device, actuating unit and self-locking mechanism. Wherein the power unit serves to output torque, the transmission device transmits the torque to the actuating unit so as to make the linear actuator work. The self-locking mechanism has a spring, with which to cooperate with the transmission device and the actuating unit, so as to have a dual direction self-locking function. And thus the self-locking mechanism can lock the actuating unit automatically after the linear actuator stopped working, so as to lock the load at the position where the power stop.

The present invention uses the transmission device, the actuating unit and a self-locking device to cooperate with each other, so as to achieve the above-mentioned function of dual direction self-locking. Wherein the transmission device and the actuating unit are designed as being coaxially connected. The transmission device includes at least two engaging members, whereas the actuating unit is provided with mechanism for cooperating with the engaging members of the transmission device, such that the transmission device and the actuating unit can be driven by each other for purpose of torque transmission. The spring of the self-locking mechanism is then mounted between the transmission device and the actuating unit. When the transmission device together with the actuating unit are driven to rotate by the power unit for pushing the load, the spring will be simultaneously driven to rotate. However, when the power unit stops outputting dynamic force at any position, the transmission device is unpowered. At the moment, the actuating unit, under the influence of gravity of the load, will be driven the rotate in a reversed direction. In the reversed rotation of the actuating unit, the spring will expand outward to produce a friction against internal surface of a sleeve of the transmission device, so as to lock the linear actuator automatically. On the other hand, when the power unit starts to output dynamic force again to push the load, the transmission device will push the spring to rotate inward and make it shrink back, so as to unlock the linear actuator and rotate together with the transmission device, and thus no extra load on the power unit will be caused. In this way, the linear actuator of the present invention is possessed with the function for dual direction self-locking.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a partial exploded view of a linear actuator with dual direction self-locking mechanism in accordance with the present invention;

FIG. 2 is a front cross sectional view of a self-locking mechanism of the present invention;

FIG. 3 is a back cross sectional view of a self-locking mechanism of the present invention.

### DETAILED DESCRIPTION OF THE PREFERRED EMBODIMENTS

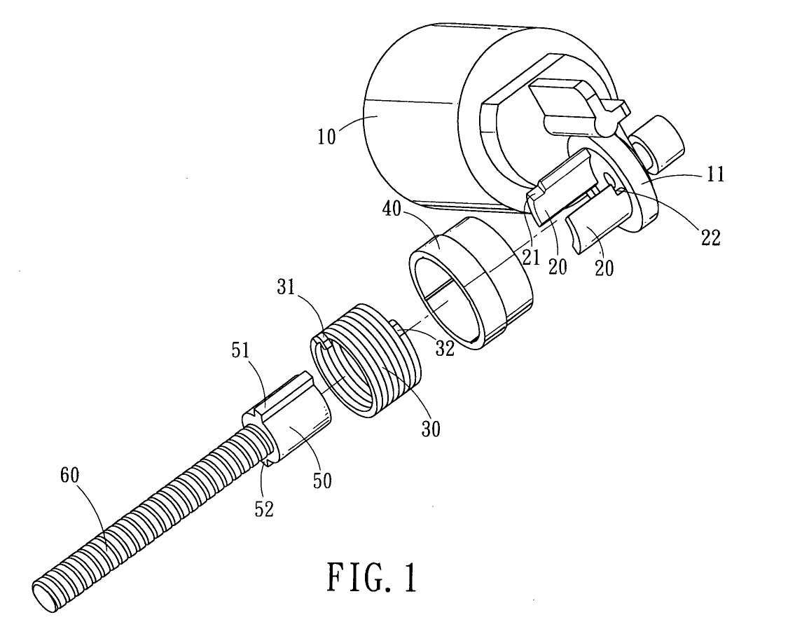

Referring to FIG. 1, which is partial exploded view of a linear actuator with dual direction self-locking mechanism in accordance with the present invention. Wherein a power unit 10 serves to drive a scroll wheel 11. On the scroll wheel 11 is provided with two engaging members 20 serving as a transmission device (the transmission unit may includes three, four or more pieces of engaging member 20). An actuating unit generally comprises a coupling portion 50, a screw shaft 60 and a screw nut (not shown). The engaging members 20 serve to engage with the coupling portion 50. With an upper and a lower longitudinal keys 51, 52 on the coupling portion 50, the coupling portion 50 can be driven by the engaging members 20 for transmitting torque to the screw shaft 60, and then to drive the screw nut (not shown) for actuating the operation of the linear actuator. The two engaging members 20 are exteriorly provided with a spring 30 which having a front hooked end 31 and rear hooked end 32. On the outer side of the spring 30 is further provided with a sleeve 40. In order to firmly fix the spring 30, one of the engaging members 20 is defined with a front notch 21 and the other of the engaging members 20 is formed with a rear notch 22 for respectively engaging with the front and the rear hooked ends 31, 32 of the spring 30.

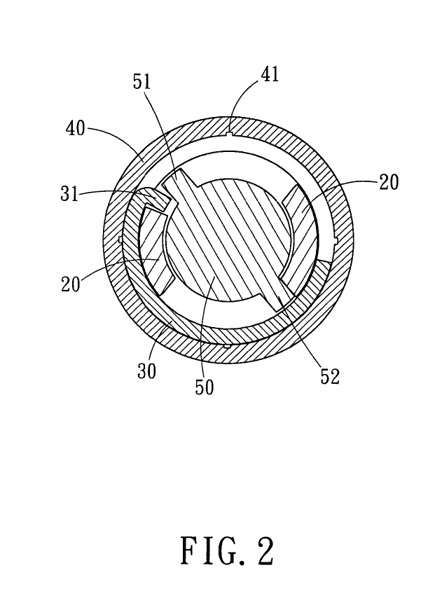

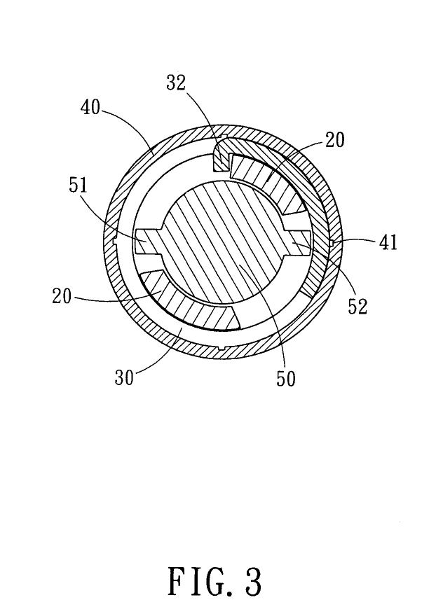

Referring to FIGS. 2-3, FIG. 2 is a front cross sectional view of the linear actuator with dual direction self-locking mechanism in accordance with the present invention. FIG. 3 is a back cross sectional view of the linear actuator with dual direction self-locking mechanism in accordance with the present invention. In which, in case of outward rotation of the linear actuator, the power unit drives the two engaging members 20 to rotate clockwise, the engaging members 20 further drive the upper and the lower longitudinal keys 51, 52 of the coupling portion 50 to rotate so as to transmit torque and push out the load. Meanwhile, the front notch 21 of the coupling engaging members 20 drives the spring 30 to rotate together by pushing the front hooked end 31. At this moment, the direction of the dynamic force's transmission is identical to that of the spring's 30 motion (which shrinks inward), thereby the spring 30 can be driven to rotate only by a small force. Under this load condition, if the power unit stops outputting dynamic force (including the condition that the linear actuator reaches and stops at the stroke end), the two engaging members 20 will be unpowered, and thus the coupling portion 50 will be driven to rotate counterclockwise by an opposite force to the load, viz. counterclockwise force (as can be seen in FIG. 2). The counterclockwise force, through the upper longitudinal key 51 of the coupling portion 50, is applied on the front hooked end 31 of the spring 30, such that the spring 30 will expand outwardly to abut against the internal surface of the sleeve 40 and cause a friction (self-locking force) therebetween. The self-locking force is exactly equal to the load, and thus firmly locks the load at a position where the power unit stopped outputting dynamic force. At this moment, if the power unit starts again to push out the load (suppose that the load didn't stop at the stroke end), the two engaging members 20 will be driven to rotate clockwise again (as can be seen in FIG. 2), the engaging members 20 then drive the front hooked end 31 of the spring 30 to rotate so as to make it shrink back, and thus the spring 30 is unlocked. In this case, the two engaging members 20 are allowed again to drive the spring 30 and the coupling 50 to rotate clockwise together for making the linear actuator continue to push out the load. On the other hand, when the power unit starts again to withdraw the load, the power unit will drive the two engaging members 20 to rotate counterclockwise (as shown in FIG. 3), at this moment, the engaging members 20 drive the rear hooked end 32 of the spring 30 to rotate counterclockwise and make the spring shrink inward, thus the spring 30 is unlocked. After that and again, the two engaging members 20 can drive the coupling portion 50 and the spring 30 to rotate counterclockwise so as to withdraw the load.

In case of inward rotation of the linear actuator, the operation is exactly reversed, that is to say that when the two engaging members 20 are driven to rotate counterclockwise by the power unit (as shown in FIG. 3), the engaging members 20 will drive the rear hooked end 32 of the spring 30 to rotate so as to make spring shrink back, and the coupling portion 50 is driven to rotate together so as to withdraw the load. When the power unit stops outputting dynamic force, the engaging members 20 are unpowered. The coupling portion 50 will be driven to rotate clockwise by an opposite force of the load, which causes a clockwise rotation of the upper longitudinal key 51 of the coupling portion 50 together with the rear hooked end 32 of the spring 30, and as a result, the spring 30 is expanded outward and locked automatically. If want to unlock it, the power unit only needs to drive the two engaging members 20 to rotate clockwise again (counterclockwise) so as to make the engaging members 20 push the front hooked end 31 (or the rear hooked end 32) of the spring 30 to shrink inward, and the spring 30 will be shrunk back and unlocked when the withdrawn torque is transmitted to the rear hooked end 32 (or front hooked end 31). Thereby, the two engaging members 20 can synchronously drive the spring 30 and the coupling portion 50 to rotate clockwise (or counterclockwise) for pushing out (or withdrawing) load.

In addition, since self-locking force is caused by the friction between the spring 30 and the internal surface of the sleeve 40, on the internal surface of the sleeve 40 can be additionally provided with plural oil grooves 41 for purpose of increasing friction and lubricating, and thus the linear actuator can be prolonged in service life.

While we have shown and described various embodiments in accordance with the present invention, it should be clear to those skilled in the art that further embodiments may be made without departing from the scope of the present invention.

1. A linear actuator with dual-direction self-locking mechanism including:
a power unit serving to output torque;
a transmission device having two engaging members for serving to transmitting the torque of the power unit;
an actuating unit having a coupling portion, a screw shaft and a screw nut, the coupling portion employed to engage with the two engaging members for turning the torque into linear motion, so as to drive a load to move linearly; and
a self-locking mechanism having a spring for cooperating with the transmission device and the actuating unit, so as to have a self-locking function, the spring being mounted on the outer side of the engaging members, both ends of the spring being forming with a hooked end, on the outer side of the spring a sleeve mounted, on the internal surface of the sleeve formed with plural grooves, such that the self-locking mechanism can be possessed with dual direction self-locking ability without producing extra load.

2. The linear actuator with dual-direction self-locking mechanism as claimed in claim 1, wherein one of the two engaging members is provided with a front notch and another engaging member is provided with a rear notch for respectively engaging with the hooked ends of the spring, with which to firmly fix the spring.

3. The linear actuator with dual-direction self-locking mechanism as claimed in claim 1, wherein on the coupling portion of the actuating unit is provided with longitudinal keys for engaging with the engaging members of the transmission device, and thus the coupling portion can be driven by the transmission device.

4. The linear actuator with dual-direction self-locking mechanism as claimed in claim 1, wherein when direction of dynamic force's transmission is caused by the load for effecting rotation of the actuating unit, the coupling portion will push a hooked end of the spring to rotate for making the spring expand outward to cause a friction against the internal surface of the sleeve, and thus the linear actuator is locked.

5. The linear actuator with dual-direction self-locking mechanism as claimed in claim 1, wherein when direction of dynamic force's transmission is transmitted through the power unit to the transmission device and then to the actuating unit, the engaging members will push a hooked end of the spring to make the spring shrink back and unlock the linear actuator, the engaging members are able to drive the coupling portion and the spring to rotate together, so as to enable the linear actuator to drive the load to move linearly.
